(19) United States
(12) Patent Application Publication
(10) Pub. No.: US 2003/0132309 A1
(43) Pub. Date: Jul. 17, 2003

(54) WASHER-LIQUID SPRAYER FOR VEHICLE

(76) Inventor: Won Jong Kim, Suwon-shi, Kyunggi-do 442-400 (KR)

(21) Appl. No.: 10/065,852

(22) Filed: Nov. 26, 2002

(30) Foreign Application Priority Data
Jan. 17, 2002 (KR) 2002-0001456

(51) Int. Cl. B05C 1/00

(52) U.S. Cl. 239/135

(57) ABSTRACT

### Abstract of Disclosure

A washer-liquid spray device according to present invention has washer-liquid heater between washer-liquid spray pump and transfer pipe. By this heater, it is possible to provide warm washer-liquid or washer-liquid steam. So as occasion demands, driver can spray warm washer-liquid or steamed washer-liquid even in the coldest season or heavy rain to clean the car window to provide for much safer driving conditions.

### Cross Reference to Related Applications

The present application claims priority to Application No. 2002-0001456, filed in the Republic of Korea on January 17, 2002, herein incorporated by reference.

### Background of Invention

### Field of the Invention

The present invention is related to car washer-liquid sprayer. Specially, as occasion demands, it relates to washer-liquid sprayer that can be used even in the cold and heavy rain by spraying warm, heated or steamed washer-liquid into a front or rear window where window wiper is installed.

### Description of the Prior Art

In general, a window wiper (brush) is installed in front and sometimes rear window. Such window wiper cleans the window of car so that driver can have a clear view and it helps driver to drive safely. Also, there is another device to clean a window, namely a washer-liquid sprayer, which together with window wiper, cleans a window. Washer-liquid sprayer sprays washer-liquid to a vehicle window or headlamp where a window wiper is installed to assist in the removal of dirt, grime and dust on the window or headlamp.

Fig 1 shows the composition of existing washer-liquid sprayer briefly. According to Fig. 1, existing washer-liquid sprayer consists of following devices. A washer-liquid container (101) that contains washer-liquid; spray pump (102) that sprays washer-liquid from the washer liquid container (101) with fixed pressure onto the vehicle glass; and a running motor(103) that powers the pump (102) to appointed place; spray nozzle(105) built in the end of a transfer pipe (104), which sprays sent washer-liquid finally to car glass window (120).

By the way, above mentioned washer-liquid spray device of existing car sprays cold temperature washer-liquid. As such, it may perform poorly when snow is deposited or frozen on the window or specific dust is adhered to the window.

### Summary of Invention

According to the present invention, a washer-liquid sprayer consists of following parts. Between the spray pump of existing washer-liquid sprayer and washer-liquid transfer pipe, a heater is installed to one part of the body. To heat the washer-liquid and then spray warm or steamed washer-liquid, washer-liquid heater is installed. For the washer-heater, power is supplied from battery of the car. At an appointed place of front part of driver"s seat, for spray those washer-liquid and steam heated by above-mentioned washer-liquid heater, handling switch is installed. At an appointed place inside of car body, to control above-mentioned handling switch and front part of washer-liquid heater, washer-liquid heater controller is installed. According to present design, additional washer-liquid heater is prepared to supply warm or steam the washer-liquid. Because of that, it is possible to spray warm washer-liquid or steamed liquid when needed, so that a user can wash the car window to be clear despite of the cold or heavy rain. Accordingly the present invention provides the advantage of safer driving by a driver.

### Brief Description of Drawings

The present invention will now be described by way of exemplary embodiments, to which it is not limited, with reference to the accompanying drawings.

Fig. 1 is component figure of washer-liquid sprayer of existing car.

Fig. 2 is figure of washer-liquid sprayer according to present invention.

Fig. 3 is system component figure of washer-liquid heater control part of washer-liquid sprayer according to present invention.

### Detailed Description

As shown in the accompanying drawings, the present invention will be explained by the illustrated embodiments in which reference numbers 101, 201 refer to a washer-liquid container; 102, 202 refer to a spray pump; 103, 203 refer to a running motor; 104, 204 refer to a transfer pipe; 105, 205 refer to a spray nozzle; 120, 220 refer to a car window; 206 refers to a washer-liquid heater; 207 refers to a container; 208 refers to a heater; 209 refers to a lower level detector; 210 refers to an auto-thermostat; 211 refers to an auto pressure regulator valve; 212 refers to a pressure gauge; 213 refers to a washer-liquid/steam outlet; 214 refers to a outlet for decompression; 230 refers to a car battery; 240 refers to a discharge device for rest washer-liquid; 250 refers to a heater on/off switch; 301 refers to a main control part of washer-liquid heater; 302 refers to a warm washer-liquid switch; and 303 refers to a washer-liquid steam switch.

In general, window brush (wiper) is installed in front or rear window or headlight. Such a window wiper cleans the window of the car so that driver can have clear sight and it helps driver to drive safely. And also, there is another device to help clean a window, namely a washer-liquid sprayer that, together with window wiper, removes dirt and dust from the window. The washer-liquid sprayer sprays washer-liquid to vehicle glass where a wiper is installed to remove dust and grime on the window.

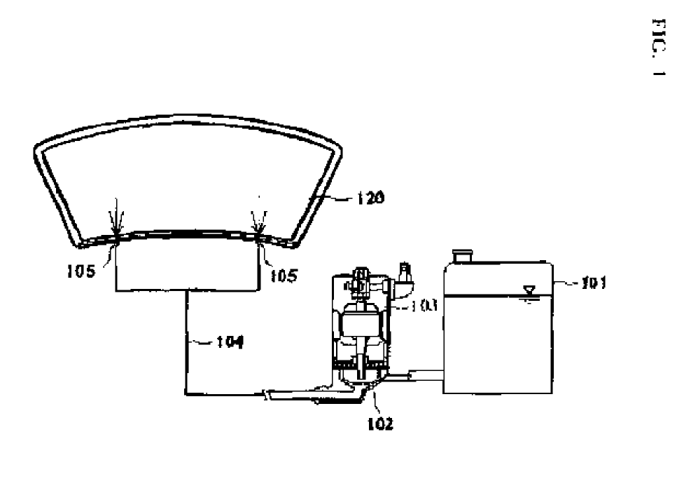

Fig 1 shows the composition of existing washer-liquid sprayer briefly. According to Fig. 1, existing washer-liquid sprayer is consist of following devices: a washer-liquid container (101) that contains washer-liquid; spray pump (102) which sprays washer-liquid of washer liquid container (101) with a fixed pressure; a running motor (103) which operates the spray pump (102); a transfer pipe (104) which sends sprayed washer-liquid from the spray pump (102) to appointed place; spray nozzle (105) built in the end of transfer pipe (104), which sprays sent washer-liquid finally to car front (or rear) window (120) or headlight.

By the way, above mentioned washer-liquid spray device of existing car sprays cold temperature washer-liquid, so it may perform poorly when snow is deposited or frozen on the window or specific dust is adhered to the window.

The technical task of the present invention is to solve the above-mentioned problem. As occasion demands, it can spray warm washer-liquid or steamed liquid so that it can clean car window regardless of the coldest season or heavy rain.

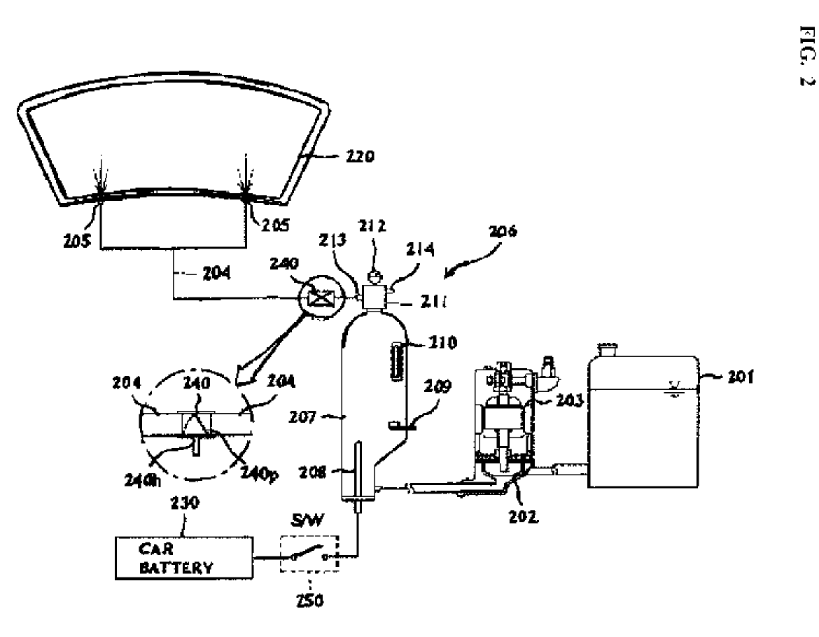

The composition and application of the present inventionachieves above-mentioned purposes. The present invention has distinguishing features relative to washer-liquid container which contains washer-liquid, pump running motor, washer-liquid transfer pipe which sends sprayed washer-liquid, washer-liquid spray nozzle which sprays sent washer-liquid onto car window. For instance, the present invention as a car washer-liquid spray device is equipped with a device which applies heat to washer-liquid supplied from container by spray pump to an appointed temperature and transfers warm washer-liquid or steam to above mentioned transfer pipe. The heater can be located between above-mentioned washer-liquid spray pump and transfer pipe. The heater is supplied power from car battery and emits heat. A lower level detector which senses lower level of washer-liquid in the container; and an auto thermostat controls the temperature in the container to fixed temperature range. At an appointed place on the container, the washer-liquid heating device including auto pressure adjust valve which sprays warm washer-liquid or steamed washer-liquid and opens automatically if pressure inside of container exceeds to fixed pressure and so decompresses the inner pressure of container. At an appointed place of front place around driver's seat, a control switch controls the above-mentioned washer-liquid heater for spraying warm washer-liquid and steam. At an appointed place in the car body, washer-liquid heater control section controls above mentioned control switch and whole part of washer-liquid heater. More detail explanations will follow with reference to the attached figures. Fig. 2 shows composition of washer-liquid spray device according to the present invention.

In reference to Fig. 2, the washer-liquid spray device according to the present invention basically has same composition with existing washer-liquid spray device, but with several distinctions. That is to say, car washer-liquid spray device according to the present invention is basically equipped with following devices: A washer-liquid container (201) which contains washer-liquid, a spray pump (202) which sprays washer-liquid from the washer-liquid container (201) at a fixed pressure, a running motor (203) which operates spray pump, a transfer pipe (204) which sends sprayed washer-liquid by spray pump (202) to an appointed place, a spray nozzle (105) built in the end of transfer pipe (104) and which sprays sent washer-liquid finally to car front (or rear) window (120). In addition to that, washer-liquid heater (206) is added. This heater applies heat to washer-liquid supplied from washer-liquid container (201) through spray pump (202) as fixed temperature. As shown in the figure, above mentioned washer-liquid heater (206) includes container which has a main body, heater installed at appointed place of the container (207), a lower level detector (209), a thermostat (210) and an auto pressure adjust valve (211).

The above-mentioned container (207) can be made in various sizes, but it usually made in about 500cc bulk. To make this container (207), a common metal can be used but stainless steel is highly suggested. And because of its functional or structural character, it should keep the temperature of heated washer-liquid in the container. And it should support certain pressure inside of the container, a heat insulation pressure container can be used.The above-mentioned heater (208) is supplied with direct current (DC 12V) from car battery through electronic connection. This heater (208) can be shaped into stick bar or coil. Above-mentioned lower level detector (209) detects lower level of washer-liquid in the container. This detector senses if the quantity of washer-liquid is not a minimum quantity. In addition to that, this detector prevents damage that can be caused in the situation that heater works when no washer-liquid exists. According to this low level detector (209), when such situation occurred, the heater (208) will not be operational. For instance, power supplied to heater (208) can be cut off by electronic circuit in such a situation.

The above-mentioned auto thermostat (210) adjusts the temperature in the container (207) to certain range of temperature. That is to say, this auto thermostat (210) detects inner temperature of the container (207). It means that if inner temperature excesses certain range of temperature, switch off is occurred so power supplied from the battery (230) to the heater (208) is cut off. In other hands, if inner temperature falls certain temperature or lower, a switch on occurs so power is supplied from battery (230) to heater (208). At this time, temperature range can be set when present invention is made or when present invention is installed in the car after releasing present invention.

The above-mentioned auto pressure adjust valve (211) is opened automatically when pressure in the container is excessively high. From this function, it reduces the pressure in the container. Such an auto pressure adjust valve (211) includes a combined structure of electronic valve mechanism and a mechanical valve mechanism. In electronic valve mechanism, a washer-liquid and steam outlet (213) is prepared and a decompression outlet (214) is prepared in mechanical valve mechanism. Also, on one side of valve body, pressure gauge (212) is installed to measure inner pressure of container. According to such composition, if pressure in the container (207) exceeds certain pressure, the above-mentioned decompression outlet (214) is opened automatically. After that, high-pressure air is released so inner pressure is reduced. This procedure prevents explosion of container (207) by excessive pressure rise.

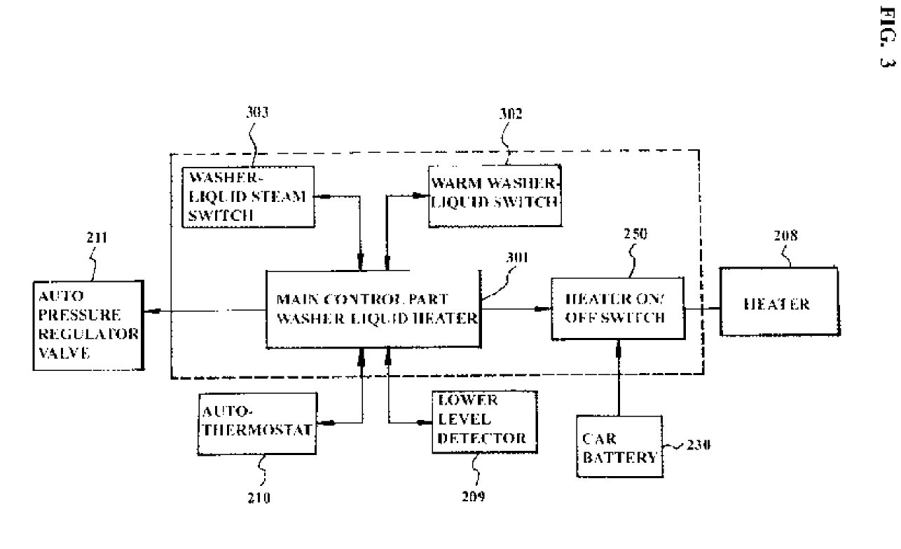

In addition, on the way of the above-mentioned outlet (213) of washer-liquid heater (206) to near transfer pipe (204), desirably, washer-liquid outlet device (240) is installed to discharge the rest of washer-liquid outside of transfer pipe (204). This device is used to discharge the rest of the washer-liquid so it prevents transfer pipe (204) from being burst by freezing washer-liquid remaining in pipe in a cold season. As illustrated in part expand figure, in washer-liquid outlet device for the rest (240), when washer-liquid moves to spray nozzle (205), valve sub-material (240P) is lying down by the pressure. The valve sub-material blocks outlet valve (240h) so washer-liquid keeps moving through washer-liquid transfer pipe (204). On the other hand, when washer-liquid is not used, pressure of washer-liquid is released then valve sub-material (240P) is restored. So, the rest washer-liquid remained in transfer pipe (204) between washer-liquid outlet device for the rest (240) and spray nozzle (205), is sprayed outside through outlet valve (240h). Reference number 220 in Fig. 2 shows the front window (or rear window) of the car. Meanwhile, Fig. 3 shows brief system composition figure of washer-liquid heater control section of washer-liquid spray device according to above-described invention.

As referred in Fig. 3, control system of washer-liquid heater (206) includes washer-liquid heater main control section (301), warm washer-liquid switch (302), washer-liquid steam switch (303), heater on/off switch (250), lower level detector (209) which is installed in washer-liquid heater (206), auto thermostat (210) and auto pressure adjust valve (211) (inner electronic valve mechanism). In the figure, inner constituents of square box, which is marked with dotted line are installed inside of car and body. Heater on/off switch (250) can be separated from main control section (301) or unified with main control section (301) as one chip. In addition to that, above mentioned warm washer-liquid switch (302) and washer-liquid steam switch (303) are installed at an appointed place of front part where various control switch of driver's seat is installed. At this point, in above mentioned main control section (301), a kind of control program is made and saved in built-in memory. This control program receives input signal from above mentioned panel control switch and electronic devices connected to main control section (301) (command signal by adjust switch and sensing signal by detector). After that, the program transmits control command or manages the command. According to the present invention that has above-mentioned composition, movements of car washer-liquid spray device occur as follows.

When driver operates existing washer-liquid spray control bar installed in handle axis to clean front window (or rear window) of car, washer-liquid inside washer-liquid container (201) flows into the washer-liquid heater container (207) through the spray pump (202) by means of the running motor (203) and the spray pump (202). When washer-liquid is filled enough in container (207). In the beginning of running present invention, it may take time until washer-liquid is filled inside container. After that, washer-liquid flows out through the washer/steam outlet prepared on one side of the auto pressure adjust valve (211). Thereafter, liquid is transferred through the transfer pipe (204) and finally sprayed to window through spray nozzle (205). A series of procedures like the above-mentioned, is a normal washer-liquid spraying process and it is not different from existing spraying process. When driver cleans car window by above-mentioned normal washer-liquid spray, he or she may have problem in the coldest season or heavy rain. To solve such problem, if driver/user pushes warm washer-liquid switch (302), washer-liquid heater main control section (301) corresponds to that input signal. And then main control section (301) verifies proper level of washer-liquid using sensing signal from lower level detector (209). If there is no problem with washer-liquid level as a result, that is to say, if there is washer-liquid enough to minimum quantity needed for washer-liquid container (207), heater on/off switch (205) is turned on. According to that, power is supplied to heater (208) from car battery (230) and heater emits heat. As heater (208) emits heat, washer-liquid temperature in the container (207) rises. If the temperature exceeds the upper limit of the fixed temperature range (for example, 30-40°C), it may take about 2-4 minutes to reach this fixed temperature range. The main control section (301) receives temperature value continuously from thermostat (210) and turns off the above-mentioned heater on/off switch (250). As a result, power supply from battery (230) to heater (208) is cut off. In such situation, if driver/user controls washer-liquid spray control bar, as stated above, the running motor (203) and spray pump (202) work. By that, washer-liquid flows into container (207) from washer-liquid container(201) through spray pump (202). After that, by the pressure of this flowing washer-liquid, washer-liquid heated to above mentioned fixed temperature in the container (207) is discharged through outlet (213). At the same time, discharged washer-liquid is transferred through transfer pipe (204) and finally, washer-liquid is sprayed to car window (220) through spray nozzle (205). That means warm washer-liquid is sprayed. By the warm washer-liquid, freezing or deposited snow on the window can be moved easily.

While, in the case that driver/user pushes washer-liquid steam switch (303), whole action mechanism is similar to above-mentioned case that driver pushes warm washer-liquid switch (302). But in this case, washer-liquid in the container should be boiling, so it takes a little bit longer to supply power from battery (230) to heater (208) (for example, about 10-15minutes). And in main control section operation according to temperature sensing value from thermostat (210), it turns off heater on/off switch (250) at the temperature different from the former case. (At this time, at the temperature of steam.) At this point, as stated before, such operation mechanism is done by control program, which is already saved in built-in memory of main control section (301). And, if driver/user pushes this washer-liquid steam switch (303), in the former case, only warm washer-liquid is finally sprayed through spray nozzle (205). In contrast to that, in this case, high temperature, high-pressure washer-steam is finally sprayed. In this manner, high temperature, high-pressure steam is much more effective to remove deposited snow on the window.

In a way, in a series process of the above, if pressure in the container (207) exceeds a fixed pressure value (established input value), outlet (214) of auto pressure adjust valve (211) is opened by that pressure. According to that, pressure in the container (207) is reduced. In a conclusion, explosion of container (207) by high pressure is prevented.

And, after spray washer-liquid through above mentioned spray nozzle (205), remained washer-liquid in transfer pipe (204) between spray nozzle (205) and washer-liquid heater (206) is discharged outside through washer-liquid outlet (240) installed in washer-liquid/steam outlet (213) of washer-liquid heater (206). Accordingly, pipe (204) burst by frozen as a result of remained washer-liquid in transfer pipe (204) is prevented.

Effectiveness of the present invention, as explained above, is provided by the washer-liquid spray device according to present invention, which has washer-liquid heater between washer-liquid spray pump and transfer pipe. By this heater, it is possible to provide warm washer-liquid or washer-liquid steam. So as occasion demands, driver can spray warm washer-liquid or steamed washer-liquid even in the coldest season or heavy rain to clean car window. In conclusion, it has advantage that it helps much safer driving.

Claims

1. A washer-liquid spray device, comprising:
a washer-liquid container which contains washer-liquid;
a washer-liquid spray pump which sprays stored washer-liquid;
a running motor operating the washer-liquid spray pump, a washer-liquid transfer pipe which transfers washer-liquid from the washer-liquid spray pump;
a washer-liquid spray nozzle which sprays sent from the washer-liquid spray pump onto vehicle glass; and
a heater which applies heat to washer-liquid supplied from container to a appointed temperature and transfers warm washer-liquid or steam to the transfer pipe, the heater being located between above mentioned washer-liquid spray pump and transfer pipe, wherein the heater is supplied power from a car battery and emits heat.

2. A washer-liquid spray device in accordance with claim 1, further comprising a lower level detector that senses lower level of washer-liquid in the container.

3. A washer-liquid spray device in accordance with claim 1, further comprising an auto thermostat that controls temperature in the container to fixed temperature range.

4. A washer-liquid spray device in accordance with claim 1, further comprising an auto pressure adjust valve that sprays warm washer-liquid or steamed washer-liquid and opens automatically if pressure inside of container exceeds a fixed pressure to decompresses the inner pressure of container.

5. A washer-liquid spray device in accordance with claim 1, further comprising a control switch to control above mentioned washer-liquid heater for spraying warm washer-liquid and steam.

6. A washer-liquid spray device in accordance with claim 1, further comprising a washer-liquid heater control section which controls above mentioned control switch and whole part of washer-liquid heater.
